(19) United States
(12) Patent Application Publication
(10) Pub. No.: US 2013/0085846 A1
(43) Pub. Date: Apr. 4, 2013

(54) SYSTEM AND METHOD FOR ONLINE SELLING OF PRODUCTS APPEARING ON A DISPLAY

(71) Applicant: Benoit Galarneau, Montreal (CA)

(72) Inventor: Benoit Galarneau, Montreal (CA)

(21) Appl. No.: 13/252,737

(22) Filed: Oct. 4, 2011

(51) Int. Cl. G06Q 30/02; G06Q 30/06

(52) U.S. Cl. 705/14.49

(57) ABSTRACT

The present document describes a system and method for online selling of products appearing in a video production on a first display, such as a TV. The products appearing in the video production which are for sale are listed in a script. The script is provided to the second display device separate and physically distinct from the first display. The second display device generates a selection icon giving the user the option to make a product selection. The products selected by the user may be saved in a list for a later checkout. The script may be synchronized with the video production so that the selection icon of a certain product appears in synchronization with an event in the video production. In an embodiment, the selection icon is generated as the product appears on the first display.

### BACKGROUND

(a) Field

The subject matter disclosed generally relates to e-commerce. More particularly, the subject matter relates to a system and method for online selling of products appearing in a video production.

(b) Related Prior Art

It is very common for the audience of movie or a TV program to like certain products appearing in a TV program or a movie. Some users also like to follow the style of a favorite character by wearing similar clothing, getting a similar haircut, or even decorating their houses/offices in a similar fashion.

Unless the brand and model of the products appearing on the screen are obvious to detect such as the brand/model of a car for example, it would be impossible for the user to purchase products similar to those appearing in the TV show being watched.

Therefore, there is a need for a system and method which allow the user to purchase products appearing in a video production, which includes an audio track, without having to perform the additional effort of searching for these products on the internet and elsewhere.

### SUMMARY

According to an embodiment, there is provided a method for online selling of products appearing in a video production provided at a first display, the method comprising: providing at a second display device separate and physically distinct from the first display, a script according to which a product is offered for sale; running the script on the second display device, the running comprising generating a selection icon giving a user an option to make a product selection; and synchronizing the script with the video production, the synchronizing comprising displaying the selection icon of the product on the second display device in synchronization with an event in the video production at the first display.

According to an aspect, the displaying further comprises displaying the selection icon of the product on the second display device in synchronization with an appearance of the product in the video production at the first display.

According to an aspect, the product comprises one or more products, the method further comprising selecting by the user, products of interest, and saving a list of selected products in a list associated to the user at the server or the second display device.

According to an aspect, the method further comprises ordering, by the user, at least a portion of the selected products, namely ordered products, the ordering comprising providing payment information and address delivery information.

According to an aspect, the ordering further comprises sending, from the server, orders to the vendors of the ordered products to deliver the ordered products according to the address delivery information.

According to an aspect, the method further comprises coordinating, by the server receipt of funds paid by the user for the ordered products and distribution to the vendors of the ordered products.

According to an aspect, the ordering further comprises purchasing products from the server directly.

According to an aspect, the ordering further comprises re-routing the user to an external server of a product provider and purchasing products from the external server

According to an aspect, providing the script comprises pulling, by the second display device, the script from a server.

According to an aspect, providing the script comprises pushing, by a server, the script to the second display device.

According to an aspect, synchronizing comprises displaying the script on the second display device at a set time in accordance with a pre-defined schedule of broadcast of the video production.

According to an aspect, wherein synchronizing comprises manually synchronizing the script on the second display device in accordance with a pre-defined event in the video production.

According to an aspect, synchronizing comprises automatically synchronizing the script with the video production based on data associated with the video production.

According to an aspect, wherein the data comprises an audio signal and the method further comprises: receiving the audio signal at the second display device; comparing the received audio signal to at least one audio sample in a database; when a matching audio sample is found, synchronizing the script with the video production based on a timestamp associated with the matching audio sample.

According to an aspect, the data is provided at a set-top box or an onboard processing unit associated with the first display, the method further comprises: providing the data at a set-top box or an onboard processing unit associated with the first display; receiving the data associated with the video production at the second display device over a communications network; the second display device extracting a timestamp from the data; and synchronizing the script with the video production based on the extracted timestamp.

According to an embodiment, there is provided a system for online selling of products appearing in a video production provided at a first display, the system comprising: a server having access to a script according to which a product appearing in the video production is offered for sale; and a second display device separate and physically distinct from the first display, the second display being in communication with the server over a communications network; wherein the second display device receives the script from the server, and runs the script generating and displaying a selection icon giving a user an option to make a product selection.

According to an embodiment, there is provided a device for online purchasing of products appearing in a video production displayed at a first display. The device comprises: a second display separate and physically distinct from the first display; a processor having access to statements and instructions which when executed cause the processor to: receive, via a communication port, a script according to which a product appearing in the video production is offered for sale; run the script on the second display generating a selection icon giving a user an option to make a product selection; synchronize the script with the video production, including displaying the selection icon of the product on the second display in synchronization with an event in the video production at the first display.

According to an aspect, the device further comprises: a microphone for receiving an audio signal associated with the video production a digital audio fingerprinting module for turning the audio signal into a digital file, namely a digital audio fingerprint; a communication port for sending the digital audio fingerprint to an external digital audio fingerprint database and for receiving a timestamp back from the external digital audio fingerprint database; and a synchronization module for synchronizing the script with the video production based on the timestamp.

According to an aspect, the device further comprises: a communication port for receiving data associated with the video production; a video information extraction module for analyzing the data received at the communication port and for extracting therefrom a timestamp; and a synchronization module which synchronizes the script with the video production based on the timestamp.

According to an embodiment, there is provided a method for online purchasing of products appearing in a video production displayed at a first display, the method comprising: receiving at a computing device separate and physically distinct from the first display, a script according to which a product appearing in the video production is offered for sale; generating on a second display on the computing device, a selection icon giving a user an option to make a product selection; and synchronizing the script with the video production, the synchronizing comprising displaying the selection icon of the product on the second display in synchronization with an event in the video production at the first display.

In the present document, the term “product” is not limited to physical items but may also include services. For example, a jacket may be a physical product of a clothing store. At the same time, a lawn-mowing service may be the product of a landscaping company. Products are characterized by, but not limited to: image, brand, retailer, size availability, color, origin, composition etc.

In the present document, the term “timestamp” means a specific time within a video production along with the identification of the video production and/or the video production supplier (e.g., the broadcaster).

Features and advantages of the subject matter hereof will become more apparent in light of the following detailed description of selected embodiments, as illustrated in the accompanying figures. As will be realized, the subject matter disclosed and claimed is capable of modifications in various respects, all without departing from the scope of the claims. Accordingly, the drawings and the description are to be regarded as illustrative in nature, and not as restrictive and the full scope of the subject matter is set forth in the claims.

### BRIEF DESCRIPTION OF THE DRAWINGS

Further features and advantages of the present disclosure will become apparent from the following detailed description, taken in combination with the appended drawings, in which:

FIG. 1 is a block diagram of an exemplary system for the online selling of products appearing on a display and a possible environment in which the system may be practiced, in accordance with an embodiment;

FIG. 2 illustrates an example of a display synchronously displaying a list of products appearing on another display, in accordance with an embodiment;

FIG. 3 illustrate an exemplary system in which orders are sent to specific externals vendors to complete the purchase;

FIG. 4 is a block diagram of an exemplary system for the online selling of products appearing on a display, in an environment where the video is not provided in accordance with a predetermined schedule;

FIG. 5 illustrates an embodiment of a synchronization system for the online selling of products where the script is synchronized with the content shown on the first display based on the audio signal contained in the video production and compared to existing information in a database for the purpose of synchronization;

FIG. 6 illustrates an embodiment of a system for the online selling of products where the script is synchronized with the content shown on the first display based on data contained in the video production and made available to the second display device by a set-top box or onboard processing unit of the first display through a communications network;

FIG. 7 is flowchart of a method for online selling of products appearing in a video production provided at a first display;

FIG. 8 is flowchart of a method for online purchasing of products appearing in a video production provided at a first display;

It will be noted that throughout the appended drawings, like features are identified by like reference numerals.

### DETAILED DESCRIPTION

The present document describes a system and method for online selling of products appearing in a video production on a first display, such as a TV. The products appearing in the video production which are for sale are listed in a script. The script is provided to a second display separate and physically distinct from the first display. The second display could be the display of a portable computing device such as an IPAD™, IPOD™, IPhone™, smart phone, Playbook™, Kindle™, personal computer or the like. The second display generates a selection icon giving the user the option to make a product selection. The products selected by the user may be saved in a list for a later checkout. The script may be synchronized with the video production so that the selection icon of a certain product appears in synchronization with an event in the video production. In an embodiment, the selection icon is generated as the product appears on the first display.

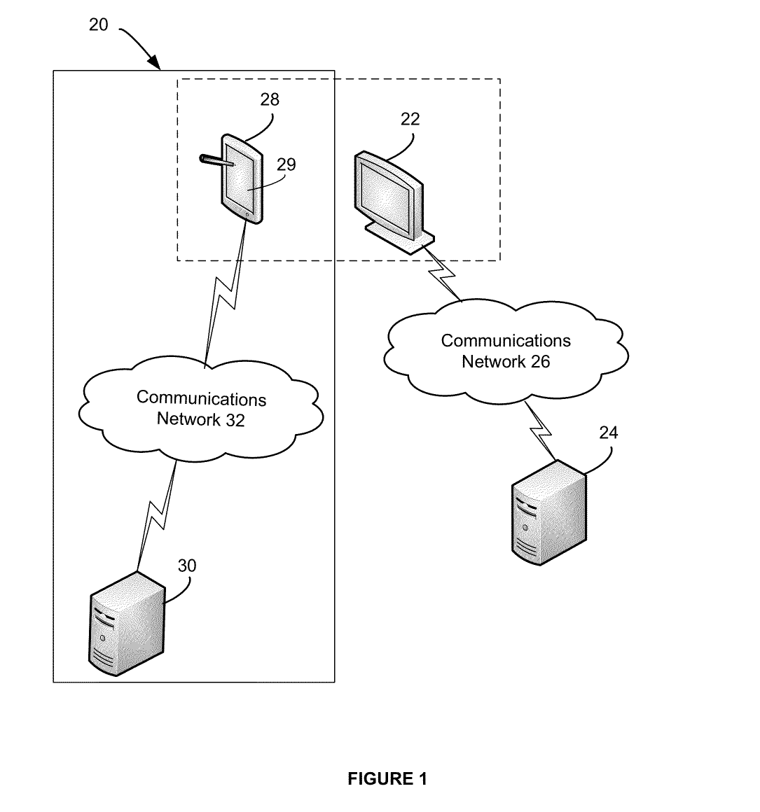

FIG. 1 is a block diagram of an exemplary system for the online selling of products appearing on a display and a possible environment in which the system may be practiced, in accordance with an embodiment.

As shown in FIG. 1, a possible environment in which the system 20 may be practiced comprises a first display 22 such as a TV screen, a computer screen, the screen of a portable computing device such as an IPAD™, Playbook™, etc. The first display 22 may be in communication with a server 24 via a communications network 26. The first display 22 displays a video production broadcast by the server 24, in accordance with a predetermined schedule. The broadcast may be web-based, via a cable network, or over the air using antennas as in the old days. The communications network 26 may include a variety of different networks including wired and wireless ones e.g. the internet, cable TV network, Wi-Fi link, microwave link, etc. An example of such environment includes a TV tuned to a certain channel.

In an embodiment, the system 20 comprises a computing device 28 comprising a second display. The computing device 28 may preferably be a portable computing device for ease of use such as an IPhone™, IPAD™, IPOD™, smart phone, PDA, portable computer, Playbook™, etc. The computing device 28 is in communication with at least one second server 30 via a communications network 32. In an embodiment, the second display 29 is adapted to display a list of products appearing on the first display 22, in a synchronous manner. For example, a brief description of a product and possibly a price may appear during or within few seconds before and/or after the product appears on the first display 22.

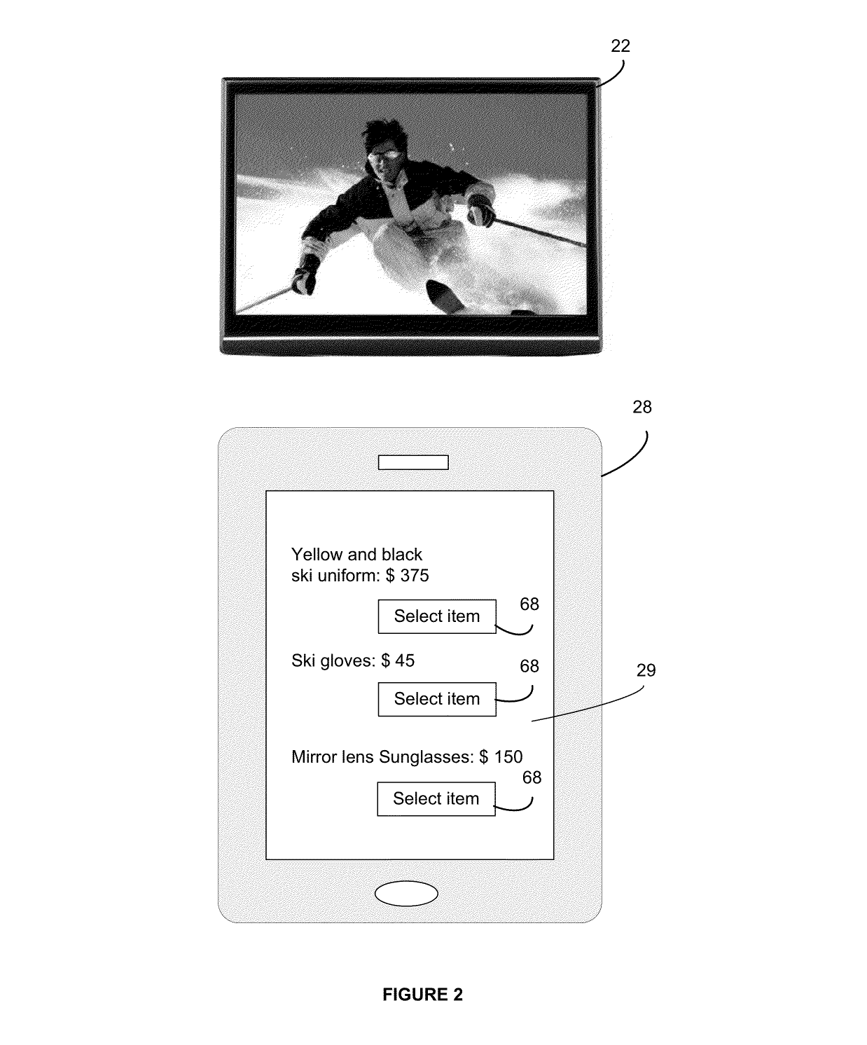

FIG. 2 illustrates an example of a second display 29 displaying a list of products appearing on another display (first display 22), in accordance with an embodiment. In the example illustrated FIGS. 1 and 2, the second display 29 displays a list of products worn by the skier shown on the first display 22 along with the price of each product and a selection icon 68. Depending on the size of the second display 29, and/or the preference of the user, it is possible to also display to the user information pertaining to the product including but not limited to: image, brand, retailer, size availability, color, origin, composition etc. In an embodiment, the products to be displayed on the second display 29 are listed in a script stored in the server 30. In the context of this description, a “script” is meant to include a schedule, defined by timestamps and programmed by an author, which determines when and which products, from one or more databases of products, will appear on the second display.

In a non-limiting method of implementation, the user may run a pre-installed application on the computing device 28 and select the channel/program aired at the first display 22. The computing device 28 may then communicate with the server 30 over the communications network 32 requesting the script corresponding to the program/movie aired at the first display 22. The server 30 then sends the script to the computing device 28 along with a timestamp for each product listed in the script so that the second display 29 may display the product description and price as the actual product appears on the first display 22.

While it is possible to have the servers 24 and 30 communicate/synchronize with each other, this is not necessary for the system 20 to operate. In particular, it would suffice for the server 30 to have the broadcasting schedule of the server 24 in order to provide the computing device 28 with the script and the timestamps in order to synchronously display the product description/pricing on the computing device 28 as they appear on the first display 22. In an embodiment, one or more synchronization points may be provided which re-synchronize the computing device 28 and/or the server 30 with the video production aired on the first display 22.

If the user is interested in buying one or more of the products appearing on the first display 22 and listed on the second display 29, they may select the products (or add them to the cart) using the computing device 28. The list of products selected by the user may be stored on the computing device 28 and/or the server 30. When it is time to checkout, the user may review the list of selected products and proceed with the purchase of some or all of the selected products.

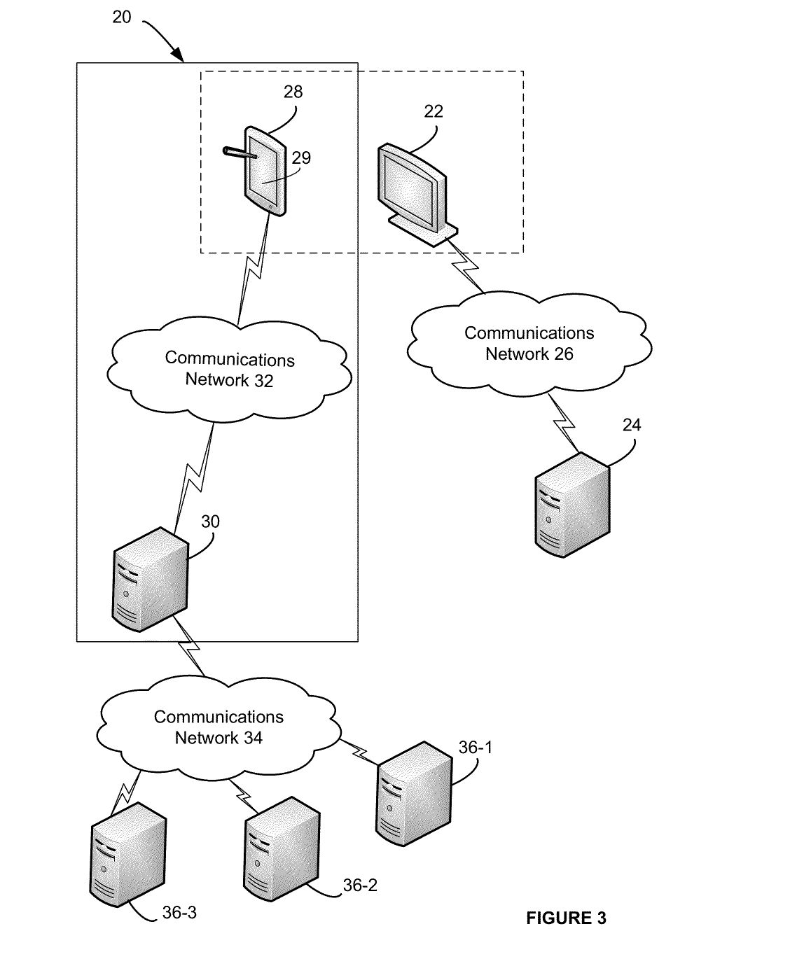

Sale of the selected products may be done in a variety of different ways. In one embodiment, the sale may be centralized whereby the user may purchase the selected products from a single server such as for example the server 30 directly. In a non limiting example of implementation, the server 30 may be the vendor itself. In another example of implementation, the server may receive the full amount and then place orders though the different providers to have the product shipped/provided at the designated address. In another embodiment, the server 30 may re-route the user to other servers to purchase the different products. For example, if at the end of a movie on the first display, the user selects products from different providers; e.g., a cleaning service, a jacket, a painting, etc., the user may place his order on a single server 30. The orders may be re-routed to the different servers of the different providers to perform the purchase. An example of such scenario is shown in FIG. 3 which shows that the orders can be re-directed to servers 36-1, 36-2, and 36-3 to complete the purchase of the different products over a communications network 34.

The user may have/open a payment account using a username and password. The account may include profile information about the user, payment information such as credit card number, PayPal™ information, billing address, currency of sale etc., shipment information including shipment address, user preferences etc. This information may be pre-stored in the user-profile for ease of purchase and sale when the user selects a product to purchase it.

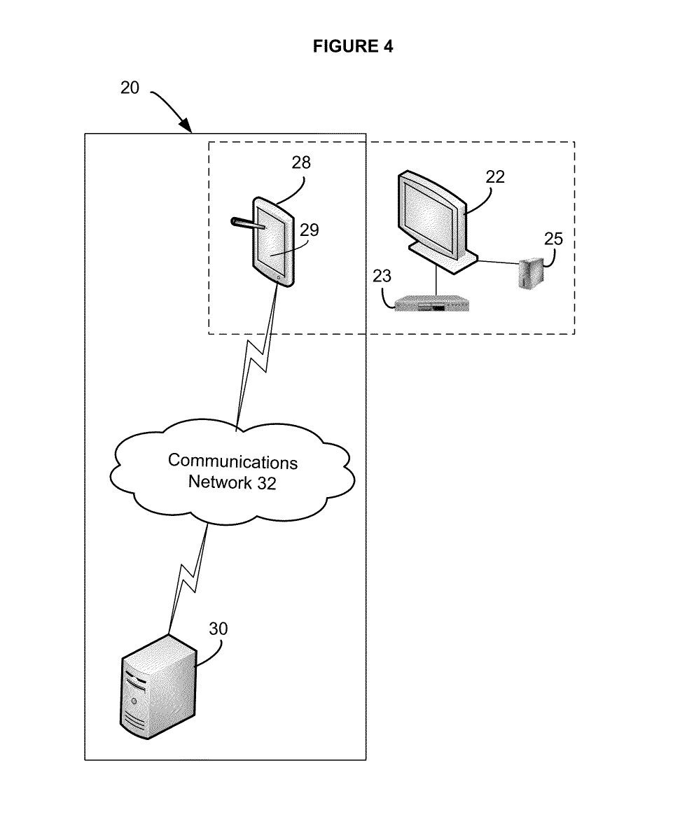

While in FIG. 1 the video production is provided in accordance with a pre-determined schedule, it should be noted that the embodiments may also be practiced in different environments where the video production is not pre-scheduled. An example of such environments is shown in FIG. 4. In the example of FIG. 4, the user may play a movie from a DVD 23, or download and watch a movie over the internet using a computer 25 without having a schedule set for playing the video. In this case, the user may search for the availability of a script based on the name of the movie. For example, the user may run the application and enter the name of the movie for which a script is needed using the interface of the computing device and hit search. The computing device 28 may then send the request to the server 30 (or other servers) to determine the presence of a script for the specified movie. If a script is found for the movie, the server 30 may provide the script along with a timestamp for the products appearing in the movie which are offered for sale. One or more synchronization points may be provided to synchronize the timestamps of the script with the movie playing on the first display 22. In an embodiment, the user may manually press a button on the computing device 28 to synchronize the script with the movie when the movie starts, or when a certain event occurs in the movie. For example, the computing device 28 may display an indication inviting the user to press a certain button upon the first appearance of a certain actor, or when a certain event occurs in the movie etc. It is possible to have multiple points of synchronization throughout the movie to re-synchronize the script with the movie playing on the first display 22.

It is also possible to automatically synchronize the script on the second display 29 with the video production on the first display 22. In one embodiment, the computing device 28 may synchronize the script with the video production using the data associated with the video production.

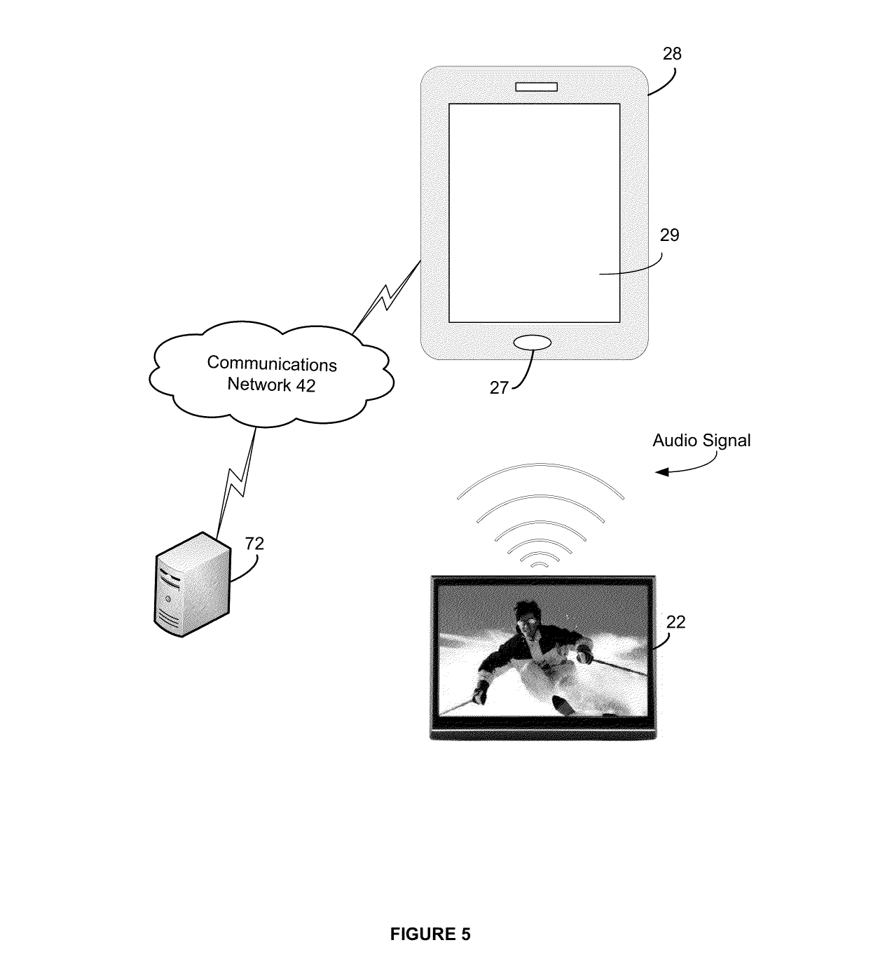

A non limiting example of implementation of this embodiment is shown in FIG. 5. As illustrated in the example of FIG. 5, the computing device 28 may receive the audio signal using a microphone 27. Using an A/D converter (not shown), computing device 28 may convert the audio signal into a unique digital audio fingerprint of the video presentation on first display 22. Computing device 28 may send the digital audio fingerprint through communications network 42 to a server 72. Server 72 compares the audio fingerprint to a set of pre-recorded digital audio fingerprint stored in a database (not shown). Each unique pre-recorded digital audio fingerprint corresponds to a specific timestamp. Once a match between the digital audio fingerprint and a pre-recorded digital audio fingerprint is found, the corresponding timestamp will be sent back to the computing device 28. Using the corresponding timestamp the computing device 28 will synchronize the script.

According to another embodiment, the synchronization is performed using an image recognition technique. In this case, the computing device 28 comprises a camera (not shown) which captures the image on the first display 22. The captured image is analyzed and compared to a database which identifies the video production on the first display 22 along with a timestamp. The timestamp is then used as discussed herein for synchronization.

It is also possible to use synchronization methods that continuously synchronize the computing device 28 with the video production based on the sound track, or other data or events provided in the video production which may be detected by the mobile device.

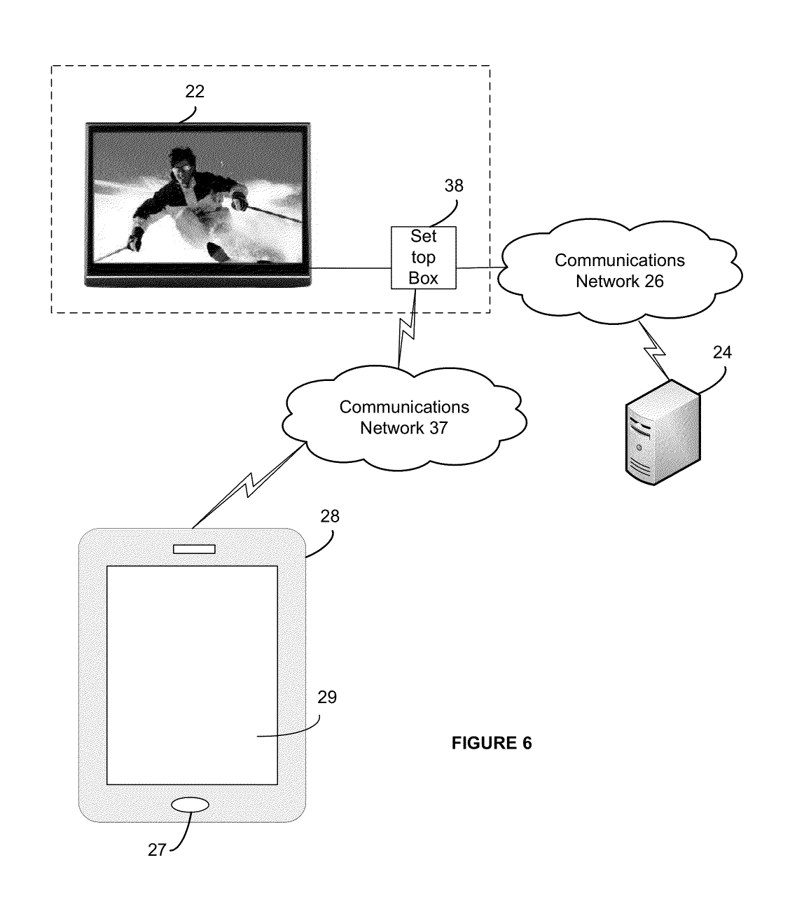

In a further embodiment, the computing device 28 may receive the timestamp from the server 24 which broadcasts the video production to the first display 22, as shown in FIG. 6. Retrieving of the information by computing device 28 can be done the following manner. Timestamp information can be found in the video production information data provided by server 24. A computing device (such as set-top box 38) next to first display 22 processes the video production signals and extracts information therefrom. Using communications network 37, set-top box 38 sends the information to computing device 28. Computing device 28 can analyze the information and extract a timestamp therefrom. Using the extracted timestamp, the computing device 28 will synchronize the script accordingly. According to an embodiment, the communications network 37 is a domestic WI-FI network. According to an embodiment, the set-top box 38 is a cable operator or satellite TV provider set-top box. It is understood that the set-top box functions can be integrated with the first display itself. Examples of such devices include SmartTV, connected TV and computers with a display. The present description is therefore meant to include such embodiments even though they are not specifically illustrated.

A set-top box is an information appliance device that generally contains a tuner and connects to a television (wired or wireless) set and an external source of signal, turning the signal into content which is then displayed on the television screen or other display device.

In the present embodiments, the script may be provided as a list of products with a timestamp for each product whereby the computing device may display the product on the second display 29 in accordance with their timestamp. In another example, the script may be provided as a notification, message, or sms including information about the product and the option to purchase the product or add it to the cart for a later checkout.

In a further embodiment, it is possible to list one or more products on the second display 29 un-synchronously with their appearance on the first display 22. In the present embodiment, the script author may use their judgment as to when to introduce the listing of a certain product. For example, it is possible to pre-select a number of products to display and/or re-display on the second display 29 based on the user's past purchases, preferences, behavior during the present/past sessions. This also allows re-introducing product listings which appeared in intense scenes where the user is less likely to look at the second display 29 to make a purchase.

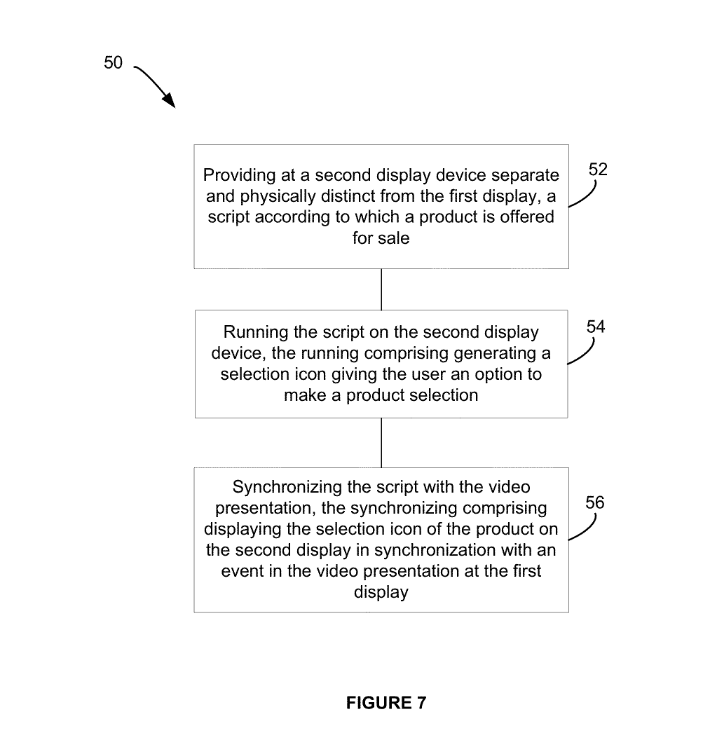

FIG. 7 is flowchart of a method 50 for online selling of products appearing in a video production provided at a first display. At step 52 the method comprises providing at a second display device separate and physically distinct from the first display, a script according to which a product is offered for sale. Step 54 comprises running the script on the second display device, the running comprising generating a selection icon giving the user an option to make a product selection. Step 56 comprises synchronizing the script with the video production, the synchronizing comprising displaying the selection icon of the product on the second display in synchronization with an event in the video production at the first display.

According to an embodiment, the method further comprises: receiving the audio signal from the first display at the second display device; transforming the audio signal into a digital audio fingerprint; comparing the digital audio fingerprint to a database of time stamped pre-recorded digital audio fingerprints; finding a match in the database for the digital audio fingerprint and retrieving the timestamp for the matching fingerprint; and synchronizing the script accordingly at the second display device.

According to an embodiment, the method further comprises: using a computing device (e.g., a set-top box or an onboard processing unit associated with the first display associated with the first display) for filtering the video presentation prior to its display on the first display; using the computing device for extracting information; using the computing device for sharing the information over a communications network; and using the second display device for accessing the shared information over the communications network and for extracting the timestamp.

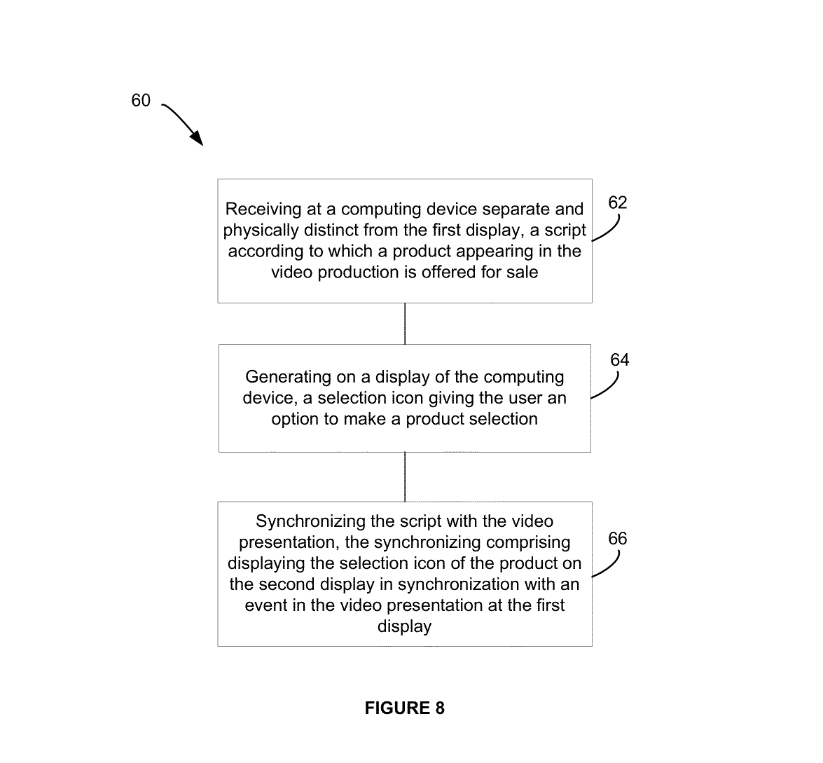

FIG. 8 is flowchart of a method 60 for online purchasing of products appearing in a video production displayed at a first display. At step 62 the method comprises receiving at a computing device separate and physically distinct from the first display, a script according to which a product appearing in the video production is offered for sale. Step 64 comprises generating on a display of the computing device, a selection icon giving the user an option to make a product selection. Step 66 comprises synchronizing the script with the video production, the synchronizing comprising displaying the selection icon of the product on the second display in synchronization with an event in the video production at the first display.

The embodiments can be implemented as a computer program product for use with a computer system. Such implementation may include a series of computer instructions fixed either on a tangible medium, such as a computer readable medium (e.g., a diskette, CD-ROM, DVD ROM, ROM, Flash Memory, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink wrapped software), preloaded with a computer system (e.g., on system ROM or fixed disk), or distributed from a server over the network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

While preferred embodiments have been described above and illustrated in the accompanying drawings, it will be evident to those skilled in the art that modifications may be made without departing from this disclosure. Such modifications are considered as possible variants comprised in the scope of the disclosure.

1. A method for online selling of products appearing in a video production provided at a first display, the method comprising:
providing at a second display device separate and physically distinct from the first display, a script according to which a product is offered for sale;
running the script on the second display device, the running comprising generating a selection icon giving a user an option to make a product selection; and
synchronizing the script with the video production, the synchronizing comprising displaying the selection icon of the product on the second display device in synchronization with an event in the video production at the first display.

2. The method of claim 1, the displaying further comprises displaying the selection icon of the product on the second display device in synchronization with an appearance of the product in the video production at the first display.

3. The method of claim 1, wherein the product comprises one or more products, the method further comprising selecting by the user, products of interest, and saving a list of selected products in a list associated to the user at a server or the second display device.

4. The method of claim 3, further comprising ordering, by the user, at least a portion of the selected products, namely ordered products, the ordering comprising providing payment information and address delivery information.

5. The method of claim 4, wherein the ordering further comprises sending, from the server, orders to vendors of the ordered products to deliver the ordered products according to the address delivery information.

6. The method of claim 5, further comprising coordinating, by the server, receipt of funds paid by the user for the ordered products and distribution to the vendors of the ordered products.

7. The method of claim 4, wherein the ordering further comprises purchasing products from the server directly.

8. The method of claim 4, wherein the ordering further comprises re-routing the user to an external server of a product provider and purchasing products from the external server.

9. The method of claim 1, wherein providing the script comprises pulling, by the second display device, the script from a server.

10. The method of claim 1, wherein providing the script comprises pushing, by a server, the script to the second display device.

11. The method of claim 1, wherein synchronizing comprises displaying the script on the second display device at a set time in accordance with a pre-defined schedule of broadcast of the video production.

12. The method of claim 1, wherein synchronizing comprises manually synchronizing the script on the second display device in accordance with a pre-defined event in the video production.

13. The method of claim 1, wherein synchronizing comprises automatically synchronizing the script with the video production based on data associated with the video production.

14. The method of claim 13, wherein the data comprises an audio signal and the method further comprises:
receiving the audio signal at the second display device;
comparing the received audio signal to at least one audio sample in a database; and
when a matching audio sample is found, synchronizing the script with the video production based on a timestamp associated with the matching audio sample.

15. The method of claim 13, wherein the data is provided at a set-top box or an onboard processing unit associated with the first display, the method further comprises:
receiving the data associated with the video production at the second display device over a communications network;
the second display device extracting a timestamp from the data; and
synchronizing the script with the video production based on the extracted timestamp.

16. A system for online selling of products appearing in a video production provided at a first display, the system comprising:
a server having access to a script according to which a product appearing in the video production is offered for sale; and
a second display device separate and physically distinct from the first display, the second display device being in communication with the server over a communications network;
wherein the second display device receives the script from the server, and runs the script generating and displaying a selection icon giving a user an option to make a product selection.

17-19. (canceled)

20. A method for online purchasing of products appearing in a video production displayed at a first display, the method comprising:
receiving at a computing device separate and physically distinct from the first display, a script according to which a product appearing in the video production is offered for sale;
generating and displaying on a second display on the computing device, a selection icon giving a user an option to make a product selection; and
synchronizing the script with the video production, the synchronizing comprising displaying the selection icon of the product on the second display in synchronization with an event in the video production at the first display.
